(19) United States
(12) Patent Application Publication
(10) Pub. No.: US 2017/0341563 A1
(43) Pub. Date: Nov. 30, 2017

(54) RETROFIT VEHICLE AUXILIARY LIGHTING

(71) Applicant: Morimoto Lighting, LLC, Atlanta, GA (US)

(72) Inventor: Matt Kossoff, Atlanta, GA (US)

(73) Assignee: Morimoto Lighting, LLC, Atlanta, GA (US)

(21) Appl. No.: 15/162,844

(22) Filed: May 24, 2016

(51) Int. Cl. B60Q 1/04; B60Q 1/00; B60Q 1/18; F21S 8/10

(52) U.S. Cl. CPC B60Q 1/0408; F21S 48/328; B60Q 1/0088; B60Q 1/18; F21S 48/1109

(57) ABSTRACT

A vehicle light assembly includes auxiliary lighting. The auxiliary light includes a base that may comprise a circuit board and a heat sink material. A series of auxiliary lights, such as LEDs, are attached to the base. A fastener extends through a mounting hole in the base to attach the base to the vehicle lighting shroud or trim. The auxiliary lights may be in an annular array, typically called a halo, or in numerous other linear or geometric shapes.

### FIELD OF THE INVENTION

The present invention relates to vehicle lighting, such as headlights and tail lights, and more particularly to retrofitting vehicle lights with auxiliary lighting.

### BACKGROUND OF THE INVENTION

Current external vehicle lighting systems are both functional and aesthetic. Numerous original equipment vehicle systems include one or more main light sources and auxiliary light sources, such as light emitting diode (LED) arrays. LED accent lighting has been available with white, amber, red or an RGB color spectrum. Modern original equipment vehicle lighting systems typically include auxiliary lighting.

Aftermarket or retrofit auxiliary lighting has also been used to add the functional and aesthetic benefits to vehicles such as cars, trucks, ATVs, snowmobiles, etc. However, it is difficult to add auxiliary lighting in a simple and aesthetic manner. Use of adhesives to secure auxiliary lighting is not desirable because of heat related problems. Wires have been used to mechanically tie an auxiliary light source to a light assembly by looping a wire entirely around the exposed face of auxiliary lighting, but this method is cumbersome and results in a crude appearance.

### SUMMARY OF THE INVENTION

The present invention is an auxiliary vehicle lighting component for mounting to a main vehicle lighting assembly trim component such as a shroud or bezel. The auxiliary lighting component includes a circuit board strip configured in an annular or non-annular shape. A series of auxiliary lights, such as LEDs, are mounted on the circuit board and spaced along the length of the circuit board strip, each light having a width extending substantially fully across the width of the circuit board. Tabs extend outwardly from one of the circuit board edges, each tab defining at least one mounting hole for mounting the auxiliary vehicle light source to a vehicle trim component, such as a primary vehicle light assembly shroud. A fastener extends through a mounting hole in the base and attaches to the vehicle. The auxiliary lights may be in an annular array, typically called a halo, or in numerous other linear or geometric shapes.

### BRIEF DESCRIPTION OF THE DRAWINGS

FIG. 1 is an exploded perspective view of a vehicle headlight with an auxiliary light source.

FIG. 2 is a perspective view of an auxiliary light source component of the present invention.

FIG. 3 is a cross-sectional view of a portion of the light source component of FIG. 2 taken through line 3-3.

FIG. 4 is a perspective view of an alternative embodiment of the auxiliary light source of FIG. 2.

FIG. 5 is a cross-sectional side view of a vehicle headlight shroud with the auxiliary light source of FIG. 2.

FIG. 6 is a cross-sectional side view of the vehicle headlight shroud with the auxiliary light source of FIG. 4 with a fastener.

FIG. 7 is a plan view of an auxiliary light source component of the present invention.

FIG. 8 is a cross-sectional side view of a vehicle headlight shroud with an auxiliary light source and an alternative fastener.

FIG. 9 is an alternative auxiliary light source component of the present invention.

### DESCRIPTION OF PREFERRED EMBODIMENTS

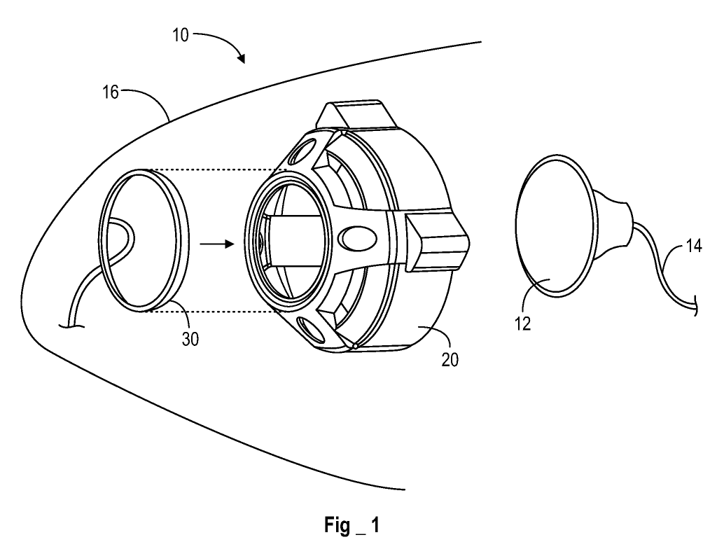

Referring to FIG. 1, a vehicle headlight assembly 10 includes a main light source 12 mounted in vehicle trim component such as a shroud or bezel 20. As used herein, trim component includes lighting shrouds, bezels and adjacent vehicle lighting components such as decorative chrome accent components. An auxiliary light source 30 is attached to the trim component as will be described herein. A plastic lens 16 encloses the internal components of the assembly 10. The main light source 12 is connected to the vehicle electrical system through wiring 14, as is well known in the art. Of course, the present invention is applicable to taillights as well.

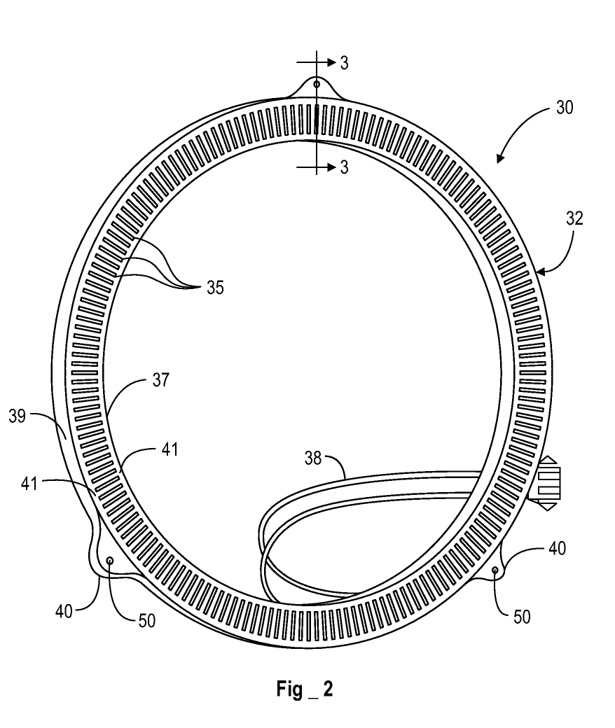

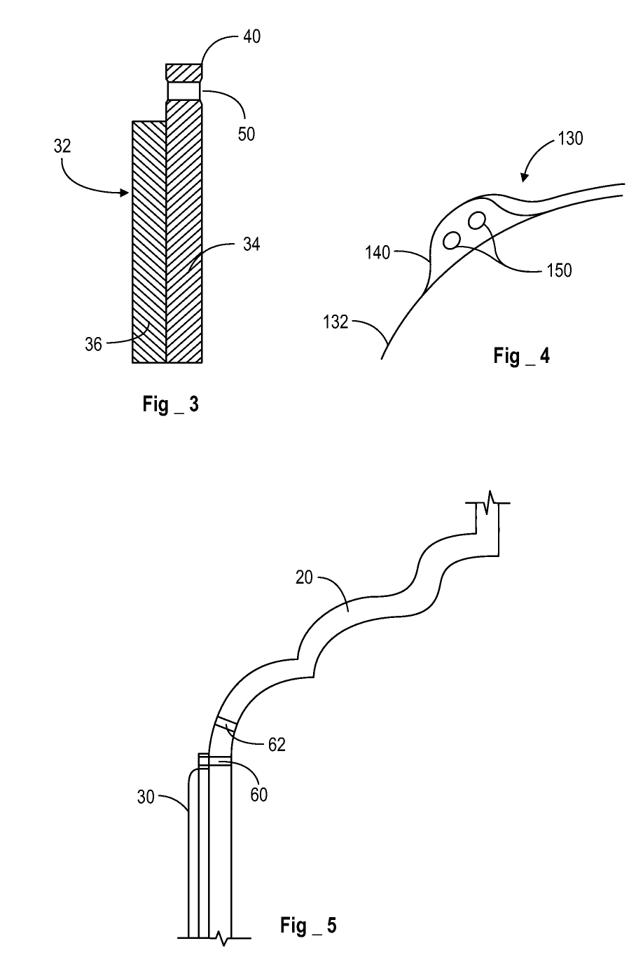

Referring to FIGS. 2 and 3, the auxiliary light source component 30 is an annular array of light emitting diodes, or LEDs, the annular component commonly known as a halo ring. Alternative light sources may be used inn place of LEDs, such as cold cathode fluorescent lighting (CCFL).

The halo ring 30 has a base 32 which includes a fiberglass circuit board 34 having an inner peripheral edge 37 and an outer peripheral edge 39. The circuit board 34 has a thickness of about two millimeters. Optionally, an aluminum heat sink 36 may be attached to the circuit board, such as by adhesive. A typical heat sink component has a thickness of one to three millimeters. Alternative materials may be used, such as a plastic circuit board and a stainless steel heat sink. A series of LEDs 35 are mounted on the circuit board in an equally spaced array as is well known in the art. An electrical connector assembly 38 is provided to connect the ring 30 to the vehicle electrical system.

The outer periphery of the ring base 32 typically has a diameter of around 50 to 160 millimeters. The width of a typical ring base 32 is about four to six millimeters. The ring base 32 includes three tabs 40 that extend about 10 millimeters radially outwardly from the outer periphery of the base. The tabs 40 extend circumferentially about 10 millimeters and are integrally formed with the fiberglass circuit board 34 by molding. A typical LED strip, regardless of shape, has about two to six LED chips per linear centimeter. Each LED chip extends nearly completely across the width of base 32, leaving only thin annular gaps 41 adjacent the inner and outer peripheries of the base. The exposed face of the base 32 may be coated with a silicone or other coating to diffuse light.

The tabs 40 are equally spaced around the outer periphery of the base. Alternatively, for certain vehicle designs, it may be preferable for the tabs to extend radially inwardly from the inner periphery of the base. While three tabs are shown, other embodiments may include from two to eight or more tabs, depending on the ring size and strength requirements. A hole 50 extends completely through each tab 40 for mounting the ring 30 to a vehicle light assembly as will be described. Each hole 50 has a diameter of about one millimeter.

Referring to FIG. 4, an alternative auxiliary light assembly 130 has a base 132 and a plurality of mounting tabs 140 (only one of which is shown in FIG. 3). Each tab 140 has a circumferential length of about ten millimeters and includes two circumferentially spaced one-millimeter diameter through holes 150. Alternatively, the two holes 150 of each tab could be radially spaced, but circumferential spacing is preferred for maintaining the low radial profile of the tab.

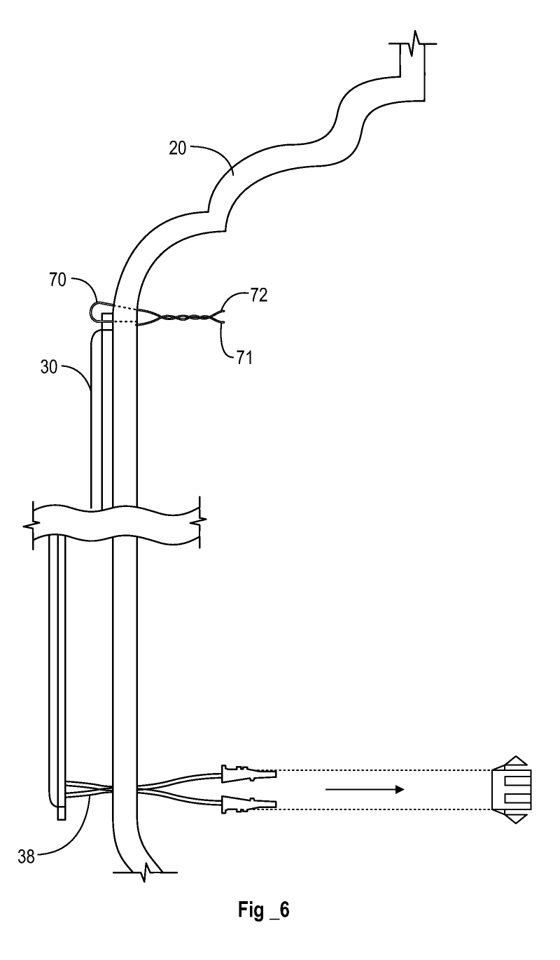

Referring to FIG. 5, the shroud trim component 20 has two mounting holes 60 and 62 corresponding to each tab 40. A mounting hole 60 is aligned with a mounting hole 50 of each tab. Mounting hole 62 is radially outwardly spaced from mounting hole 60. Referring to FIG. 6, a thin metal or plastic wire 70 is threaded thorough the tab hole 40, with one end 71 of the wire 70 threaded through inner shroud mounting hole 60 and the other end 72 threaded through outer shroud mounting hole 62. The wire ends 71 and 72 are twistingly connected to tightly secure the alternative light assembly 30 to the shroud 20. Auxiliary lighting assembly electrical wiring 38 extends into the interior of the shroud.

Alternatively, as will be readily understood, if each tab includes two holes such as 150 (FIG. 4), the wire will not have to extend over an edge of the base 130. The one or tow hole designs may be preferred for certain lighting systems.

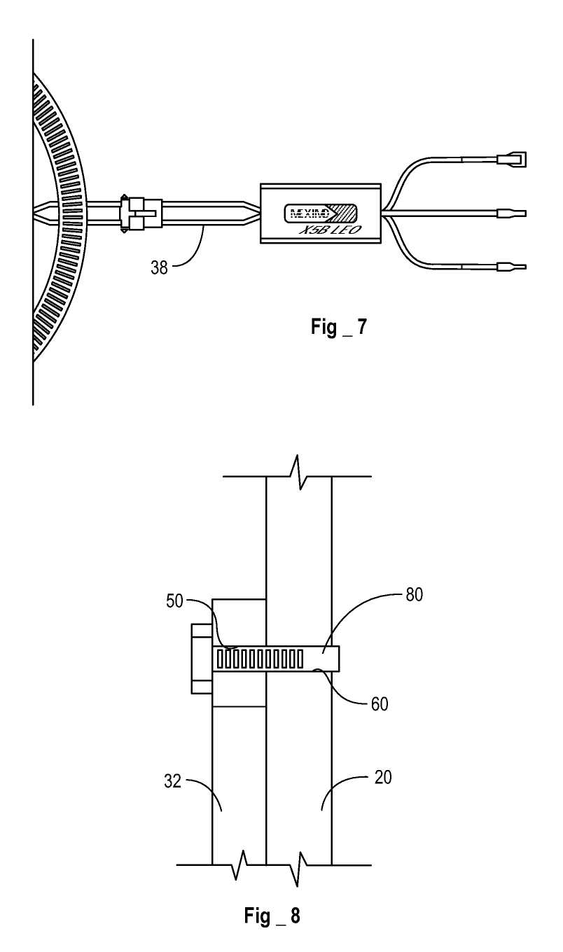

Referring to FIG. 7, the auxiliary lighting assembly wiring 38 is connected to a power source, such as the vehicle running or corner lights so that the auxiliary lights are powered when the running or corner lights are powered. Alternatively, the auxiliary lights may be powered independently of any other vehicle circuit with an independent 12-volt switch.

Referring to FIG. 8, an alternative fastener 80, such as a metal screw, may be used to secure the auxiliary light source to the shroud 20. The screw 80 extends through tab hole 40 of the base 32 and securely threads into the shroud hole 60. The benefit of this alternative is that only one hole 60 is required in the shroud. Aesthetically, the screw head is exposed rather than the wire 70 of the previous embodiment.

While the previously described embodiments include an annular auxiliary lighting component, the present invention is equally applicable to non-annular shapes of auxiliary lighting strips, such as rectangles, arcs, and linear strips. Regardless of shape, each auxiliary lighting component includes a circuit board strip having a width defined by generally parallel edges and a series of light sources extending along the length of the strip. With each shape, tabs extend outwardly generally perpendicularly to one edge of the strip away from the series of light sources.

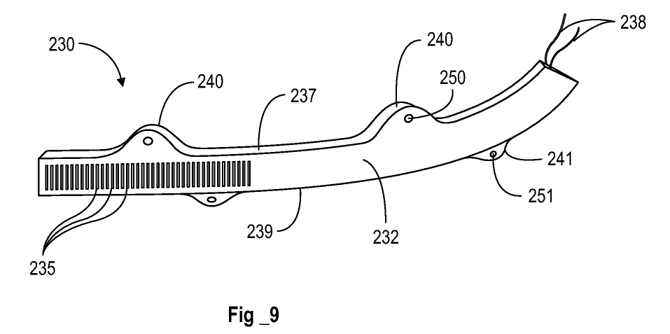

Referring to FIG. 9, an elongated auxiliary vehicle light source 230 includes circuit board 232 having LEDs 235 mounted thereon, each LED extending substantially fully between an upper edge 237 and a lower edge 239. The LEDs 235 are equally spaced along the length of the circuit board 230. Wiring 238 is provided to electrically connect the circuit board to an electric power source of the vehicle. Molded tabs 240 are provided in one edge 237 of the circuit board. Each tab 240 includes a thorough hole 250 for accepting a fastener such as 70 or 80. Optionally, tabs 241 may be provided on opposite edge 239, each tab having a through hole 251 for accepting a similar fastener. Depending on the vehicle lighting assembly design, tabs may be desired for both edges as described or only one of the edges. As with the previous described embodiments, the elongated vehicle auxiliary light 230 may be attached adjacent a vehicle headlight or taillight component as previously described.

The descriptions of specific embodiments of the invention herein are intended to be illustrative and not restrictive. The invention may be practiced otherwise than as specifically explained and illustrated without departing from its spirit or scope as defined by the appended claims.

What is claimed is:

1. A vehicle light assembly comprising:
a main light source,
a vehicle trim component adjacent the main light source,
an auxiliary light source, the auxiliary light source comprising a base and a series of auxiliary lights attached to the base,
a mounting hole extending through a portion of the base, and
a fastener extending through the mounting hole and attached to the trim component.

2. A vehicle light assembly as defined in claim 1 wherein the series of auxiliary lights are LEDs.

3. A vehicle light assembly as defined in claim 2 wherein the base includes a circuit board and wherein the LEDs built upon the circuit board.

4. A vehicle light assembly as defined in claim 3 wherein the base further comprises and a heat sink connected to the circuit board.

5. A vehicle light assembly as defined in claim 1 wherein the auxiliary lights extend along a generally linear path, and wherein the mounting hole is spaced from the path.

6. A vehicle light assembly as defined in claim 5 wherein the base is annular with generally annular inner and outer peripheries, the base further comprising a tab extending radially from a periphery of the base, wherein the mounting hole is in the tab.

7. A vehicle light assembly as defined in claim 6 wherein the tab extends radially outwardly from the outer periphery of the base.

8. A vehicle light assembly as defined in claim 6 where the base comprises a plurality of tabs, each tab defining a mounting hole.

9. A vehicle light assembly as defined in claim 5 wherein the base comprises a non-annular circuit board strip, the strip having a width defined by first and second generally parallel edges, the base further comprising a tab extending perpendicularly outwardly from an edge of the base, wherein the mounting hole is in the tab.

10. A vehicle light assembly as defined in claim 9 wherein the base is generally linear.

11. A vehicle light assembly as defined in claim 9 wherein the base has a curved shape.

12. A vehicle light assembly as defined in claim 1 wherein the fastener is a wire extending through the trim component.

13. A vehicle light assembly as defined in claim 12 wherein the wire extends through two holes in the trim component.

14. A vehicle light assembly as defined in claim 1 wherein the fastener is a screw extending into the trim component.

15. A vehicle light assembly as defined in claim 1 wherein the trim component is a lighting shroud.

16. A vehicle light assembly as defined in claim 1 wherein the tab comprises two through holes.

17. An auxiliary vehicle light source comprising a circuit board having a width extending between two generally parallel edges and a length extending parallel to the two edges, the circuit board comprising a series of auxiliary lights spaced along the length of the board, each light having a width extending substantially fully across the width of the circuit board, wherein the circuit board further comprises a plurality of tabs extending outwardly from one of the circuit board edges, each tab defining at least one mounting hole for mounting the auxiliary vehicle light source to another component of a vehicle.

18. A vehicle light assembly as defined in claim 17 wherein the circuit board is annular and the each tab extends radially from the one circuit board edges.

19. A vehicle light assembly as defined in claim 17 wherein the circuit board has a non-annular shape and each tab extends generally perpendicularly from the one circuit board edge.

20. A vehicle light assembly as defined in claim 19 wherein at least one tab extends from each circuit board edge.
